(19) United States
(12) Patent Application Publication
(10) Pub. No.: US 2010/0053256 A1
(43) Pub. Date: Mar. 4, 2010

(54) INK SUCTION APPARATUS

(75) Inventors: Sung-Nam CHO, Hwaseong-si (KR); Jae-Woo Joung, Suwon-si (KR); Sung-Il Oh, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD

(21) Appl. No.: 12/435,194

(22) Filed: May 4, 2009

(30) Foreign Application Priority Data
Aug. 28, 2008 (KR) 10-2008-084388

(51) Int. Cl. B41J 2/165

(52) U.S. Cl. 347/30

(57) ABSTRACT

An ink suction apparatus is disclosed. In accordance with an embodiment of the present invention, the ink suction apparatus, which sucks in residual ink of an inkjet head, includes: a suction nozzle, which sucks in the residual ink; a heater, which is adjacent to the suction nozzle and heats the suction nozzle to prevent the suction nozzle from being blocked by the residual ink; a nozzle cover, which is installed on the suction nozzle and opens and closes the suction nozzle to control sucking power of the suction nozzle; a collection chamber, which collects the residual ink having been sucked into the suction nozzle; and a suction pump, which generates sucking power and provides the sucking power to the suction nozzle. The ink suction apparatus can prevent a suction nozzle from being blocked when sucking in hyper-viscous residual ink and control the sucking power of the suction nozzle by controlling the suction nozzle's opening and closing.

### CROSS-REFERENCE TO RELATED APPLICATIONS

This application claims the benefit of Korean Patent Application No. 10-2008-0084388, filed with the Korean Intellectual Property Office on Aug. 28, 2008, the disclosure of which is incorporated herein by reference in its entirety.

### BACKGROUND

1. Technical Field

The present invention relates to an ink suction apparatus.

2. Description of the Related Art

With the development of inkjet technologies, inkjet equipment is increasingly commercialized for industrial applications from its conventional academic research use. However, when a pattern is printed utilizing the inkjet technologies, maintenance is essential in order to keep the printing capability of the inkjet equipment steady.

Specifically, when a certain amount of ink is printed as a pattern with the conventional inkjet technology, an ink droplet may form on a nozzle of an inkjet head, hindering a discharged ink droplet from traveling straight and thus deteriorating the printing quality. Therefore, in order to improve the straightness of the ink droplet, it is imperative to accompany a maintenance work, which involves purging a certain amount of ink and removing any residual ink formed on a surface of the nozzle.

The maintenance work has been performed in the conventional technology by purging a certain amount of ink from the nozzle of an inkjet head and then sucking in the residual ink by using a sucking apparatus.

In the conventional technology, however, any ink of hyper-viscosity at room temperature would leave and accumulate residual ink at a suction part of the suction apparatus, weakening the sucking power of the suction part. Accordingly, the residual ink in the inkjet head is not completely removed, and an ink droplet discharged from the inkjet head hampered from travelling straight. This is directly related to product defect, requiring more frequent maintenance work and dropping work efficiency.

### SUMMARY

The present invention provides an ink suction apparatus that prevents a suction nozzle from being blocked and controls the sucking power of the suction nozzle.

An aspect of the present invention provides an ink suction apparatus. In accordance with an embodiment of the present invention, the ink suction apparatus, which sucks in residual ink of an inkjet head, includes: a suction nozzle, which sucks in the residual ink; a heater, which is adjacent to the suction nozzle and heats the suction nozzle to prevent the suction nozzle from being blocked by the residual ink; a nozzle cover, which is installed on the suction nozzle and opens and closes the suction nozzle to control sucking power of the suction nozzle; a collection chamber, which collects the residual ink having been sucked into the suction nozzle; and a suction pump, which generates sucking power and provides the sucking power to the suction nozzle.

The nozzle cover can be coupled to the suction nozzle in a way that the nozzle cover slides over the suction nozzle.

There are a plurality of suction nozzles and a plurality of nozzle covers, and the nozzle cover can be operable individually.

The heater can be shaped like a board and disposed in parallel with a lengthwise direction of the suction nozzle.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a front view illustrating an ink suction apparatus in accordance with an embodiment of the present invention.

FIG. 2 is a side cross sectional view illustrating an open suction nozzle of an ink suction apparatus in accordance with an embodiment of the present invention.

FIG. 3 is a side cross sectional view illustrating a closed suction nozzle of an ink suction apparatus in accordance with an embodiment of the present invention.

### DETAILED DESCRIPTION

Certain embodiments of the present invention will be described below in detail with reference to the accompanying drawings. For better understanding overall in describing aspects of the present invention, the same reference numerals are used for the same means, regardless of the figure number.

Also, if a component is described to be coupled to another component, the coupling not only refers to those cases where the components are in direct physical contact, but also encompasses those cases where a different element or elements are interposed between the components mentioned, with the components being in contact with the different element or elements respectively.

Depending on the operation of inkjet equipment, an ink droplet may form when ink accumulates at a lower end of a nozzle of an inkjet head, thereby reducing a tendency for an ink droplet to travel straight when being ejected from the nozzle of the inkjet head. In other words, the falling ink droplet ejected from the nozzle may not fall in the direction of the gravitational force but bend toward an undesired direction.

Therefore, to maintain the printing capability of the inkjet equipment, a maintenance work is necessary, and the work can be divided into a purging work and a work of removing residual ink. That is, after purging a certain amount of ink from the nozzle of the inkjet head, the residual ink being left on the nozzle after purging can be removed.

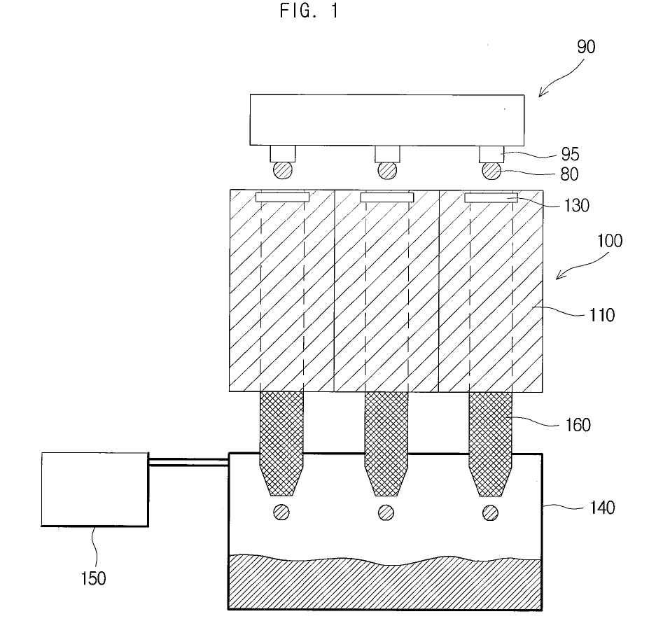

Below, an ink suction apparatus, which removes residual ink having been left on a nozzle of an inkjet head, will be described by referring to FIGS. 1 to 3.

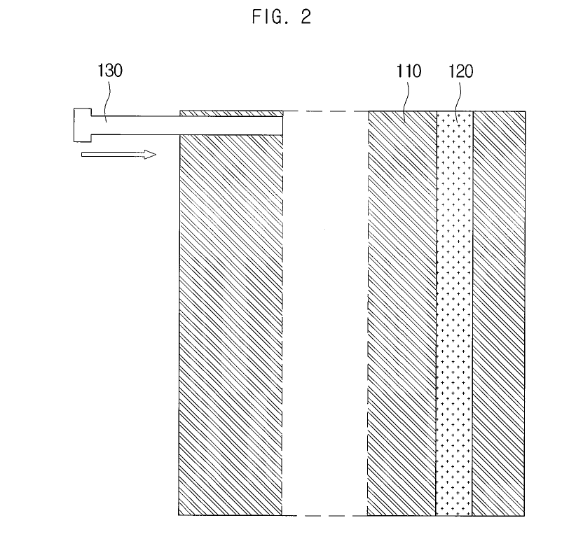

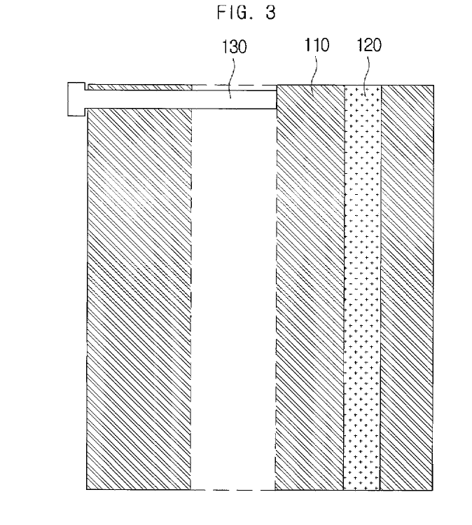

FIG. 1 is a front view illustrating an ink suction apparatus 100 in accordance with an embodiment of the present invention. FIG. 2 is a side cross sectional view illustrating an open suction nozzle of the ink suction apparatus 100 in accordance with an embodiment of the present invention. FIG. 3 is a side cross sectional view illustrating a closed suction nozzle of the ink suction apparatus 100 in accordance with an embodiment of the present invention.

As illustrated in FIGS. 1 to 3, the ink suction apparatus 100 is disclosed. In accordance with the present embodiment, the ink suction apparatus 100, which sucks in residual ink 80 of an inkjet head 90, includes: a suction nozzle 110, which sucks in the residual ink 80; a heater 120, which is adjacent to the suction nozzle 110 and heats the suction nozzle 110 to prevent the suction nozzle 110 from being blocked by the residual ink 80; a nozzle cover 130, which is installed on the suction nozzle 110 and opens and closes the suction nozzle 110 to control sucking power of the suction nozzle 110; a collection chamber 140, which collects the residual ink 80 having been sucked into the suction nozzle 110; and a suction pump 150, which generates sucking power and provides the sucking power to the suction nozzle 110.

In accordance with the present embodiment above, it is possible to prevent the suction nozzle 110 from being blocked by the hyper-viscous residual ink 80 of the inkjet head 90 by heating the suction nozzle 110 by use of the heater 120, and the sucking power of the suction nozzle 110 can be controlled by allowing the suction nozzle to be opened and closed using the nozzle cover 130.

Below, each component will be described in more detail by referring to FIGS. 1 to 3.

The suction nozzle 110 sucks in the residual ink 80. The suction nozzle 110, as described above, is an inlet for sucking in the residual ink 80 being left on a nozzle 95 of the inkjet head 90 and removes the residual ink 80 from the nozzle 95 of the inkjet head 90 by sucking in the residual ink 80 using sucking power provided from the suction pump 150 that will be described later.

There are a plurality of suction nozzles 110, each of which can be disposed in a position that corresponds with the nozzle 95 of the head 90. As a result, even if there are a plurality of nozzles 95 of the inkjet head 90, the residual ink 80 can be more efficiently removed within a short time.

In case the ink used is hyper-viscous at room temperature, the viscosity of the residual ink 80 increases as the temperature decreases while sucking in the residual ink 80 through the suction nozzle 110, thereby blocking the suction nozzle 110 due to the residual ink 80. As a result, in order to prevent a blockage in the suction nozzle 110, the heater 120 can be used, as illustrated in FIGS. 2 and 3.

In other words, as illustrated in FIGS. 2 and 3, the heater 120 is adjacent to the suction nozzle 110 and heats the suction nozzle 110 such that the suction nozzle 110 can be prevented from being blocked by the residual ink 80.

More specifically, the residual ink 80 being sucked in can be heated by disposing the heater 120 around the suction nozzle 110, As a result, the residual ink 80 can be maintained a viscosity of below 50 centipoise.

Here, the heater 120 is shaped like a board and disposed in parallel with a lengthwise direction of the suction nozzle 80. As such, the heater 120 is arranged such that the widthwise direction of the board-shaped heater 120 is parallel to the lengthwise direction of the suction nozzle 110, and thus a wider portion of the suction nozzle 110 can be more evenly heated, thereby implementing the ink suction apparatus 100 improving its suction efficiency.

The nozzle cover 130 is installed on the suction nozzle 110. The nozzle cover 130 opens and closes the suction nozzle 110 such that the sucking power of the suction nozzle 110 can be controlled. As illustrated in FIGS. 2 and 3, the nozzle cover 130 can be coupled to a upper surface of the suction nozzle 110 in a way that the nozzle cover 130 slides over the suction nozzle 110, and it is possible to control how much the suction nozzle 110 opens and closes in accordance with the sliding movement of the nozzle cover 130.

Depending on how much the nozzle cover 130 slides over the suction nozzle 110, it is possible to control how much the suction nozzle 110 opens and closes, as illustrated in FIGS. 2 and 3. As a result, even if sucking power being generated from the suction pump 150 being described later is constant, the suction strength of the suction nozzle 110 can be controlled, depending on the viscosity of the residual ink 80. Therefore, the ink suction apparatus 100, which can be applied to several different ink, can be implemented.

In other words, if low-viscosity ink, for example, metal ink, is used, it does not need huge sucking power, and thus a certain portion of the suction nozzle 110 is opened by moving the nozzle cover 130 such that the nozzle cover 130 can be located between the ones illustrated in FIGS. 2 and 3. If high-viscosity ink, for example, polymer ink, is used, it needs strong sucking power, and thus the sucking power can be controlled by opening all the suction nozzle 110, as illustrated in FIG. 2.

There are a plurality of nozzle covers 130 corresponding to the plurality of suction nozzles 110, and each of the nozzle covers 130 is able to operate individually. Since each of the nozzle covers 130 can be operated individually to open and close each suction nozzle 110, even if any nozzle 95 of the inkjet head 90 is damaged and not used, the suction nozzle 110, which is disposed in a position that corresponds with the nozzle 95 of the inkjet head 90 that is not used, can be closed, as illustrated in FIG. 3, and only by opening the suction nozzle 110 needed, as illustrated in FIG. 2, the output of the suction pump 150 is not wasted, allowing the ink suction apparatus 100 to improve its suction efficiency.

The collection chamber 140 collects the residual ink 80 that has been sucked into the suction nozzle 110. That is, the collection chamber 140, as a space for putting the residual ink 80 inside of it, can be connected with the suction nozzle 110 through a connecting tube 160, and the residual ink 80 can be collected into the collection chamber 140 through the connecting tube 160.

The suction pump 150 generates sucking power and provides the sucking power to the suction nozzle 110. In other words, since the suction pump 150 is connected with the suction nozzle 110, when the suction pump 150 works to generate the sucking power, the suction nozzle 110 can suck in the residual ink 80 having existed in the nozzle 95 of the inkjet head 90 by using the sucking power and then collect the residual ink 80 into the collection chamber 140.

According to the embodiments of the present invention as set forth above, an ink suction apparatus can prevent a suction nozzle from being blocked when sucking in hyper-viscous residual ink and control the sucking power of the suction nozzle by controlling the suction nozzle's opening and closing.

While the spirit of the invention has been described in detail with reference to a certain embodiment, the embodiment is for illustrative purposes only and shall not limit the invention. It is to be appreciated that those skilled in the art can change or modify the embodiment without departing from the scope and spirit of the invention. As such, many embodiments other than that set forth above can be found in the appended claims.

What is claimed is:

1. An ink suction apparatus configured to suck in residual ink of an inkjet head, the ink suction apparatus comprising:
a suction nozzle configured to suck in the residual ink;
a heater configured to heat the suction nozzle to prevent the suction nozzle from being blocked by the residual ink, the heater being adjacent to the suction nozzle;
a nozzle cover configured to open and close the suction nozzle, the nozzle cover being installed on the suction nozzle to control sucking power of the suction nozzle;
a collection chamber configured to collect the residual ink, the residual ink having been sucked into the suction nozzle; and
a suction pump configured to generate sucking power and provide the sucking power to the suction nozzle.

2. The ink suction apparatus of claim 1, wherein the nozzle cover is coupled to the suction nozzle in a way that the nozzle cover slides over the suction nozzle.

3. The ink suction apparatus of claim 1, wherein there are a plurality of suction nozzles and a plurality of nozzle covers, and the nozzle cover is operable individually.

4. The ink suction apparatus of claim 1, wherein the heater is shaped like a board and disposed in parallel with a lengthwise direction of the suction nozzle.
